(19) United States
(12) Patent Application Publication
(10) Pub. No.: US 2024/0419940 A1
(43) Pub. Date: Dec. 19, 2024

(54) MULTI-CRITERIA RECOMMENDER APPARATUS AND METHOD

(71) Applicant: UIF (University Industry Foundation), Yonsei University, Seoul (KR)

(72) Inventors: Won Yong SHIN, Seoul (KR); Jin-Duk PARK, Seoul (KR)

(21) Appl. No.: 18/747,294

(22) Filed: Jun. 18, 2024

(30) Foreign Application Priority Data
Jun. 19, 2023 (KR) 10-2023-0077859

(51) Int. Cl. G06N 3/042

(52) U.S. Cl. CPC G06N 3/042

(57) ABSTRACT

Provided are a multi-criteria recommender apparatus and method. The multi-criteria recommender apparatus obtains authorization for multi-criteria evaluation data provided by a user evaluating each item according to a plurality of different evaluation criteria to acquire a multi-criteria extended graph including a user node and an item node, wherein the item node is expanded into a plurality of sub-nodes according to the plurality of evaluation criteria, and selects a recommended item in consideration of the user's preferences for the plurality of evaluation criteria on the basis of embedding data that is obtained by performing a neural network operation on the multi-criteria extended graph.

### CROSS-REFERENCE TO RELATED APPLICATION

This application claims priority under 35 U.S.C. § 119(a) to Korean Patent Application No. 2023-0077859, filed in the Korean Intellectual Property Office on Jun. 19, 2023, the disclosure of which is incorporated herein by reference in its entirety.

### BACKGROUND

### 1. Field of the Invention

The present disclosure relates to a recommender apparatus and method, and more particularly, to a multi-criteria recommender apparatus and method.

### 2. Discussion of Related Art

Recommender apparatuses are widely used in various fields such as e-commerce, advertising, and social media sites as a way to provide users with appropriate solutions. In general, a recommender apparatus searches for and recommends an item suitable for a user mainly on the basis of evaluations of a plurality of other users. Further, most conventional recommender apparatuses recommend items suitable for users on the basis of evaluations based on a single criterion.

However, as individual perspectives, needs, and tastes have recently become more diverse, a problem that it is difficult to recommend items suitable for a user's needs by only using evaluations performed based on a single criterion has arisen. Accordingly, a multi-criteria recommender method that can recommend items that meet the diverse needs of each user was proposed.

In a multi-criteria recommender method, a recommended item is searched in consideration of results of users' evaluations of each item according to various evaluation criteria (e.g., quality, price, service, etc.) and of criteria that users consider important among a plurality of evaluation criteria. Therefore, unlike the conventional single-criteria recommender method, the multi-criteria recommender method is effective in improving user satisfaction and recommendation accuracy in that more personalized recommendation results are provided in consideration of a user's various perspectives and requirements.

Meanwhile, since a graph neural network (GNN) may be trained in consideration of the high-order connectivity between users and items, it is known that using GNNs in recommender apparatuses can provide high performance. In the conventional single-criteria recommender apparatus, in order to apply a GNN, users and items are each configured as nodes, and an item suitable for the user is recommended using a graph that is constructed by connecting edges according to a relationship between the users and the items.

However, there is a limitation in that, although the conventional graph composed of user-item nodes is suitable for single-criteria recommendation, it is not suitable for multi-criteria recommendation. For example, the conventional multi-criteria recommender apparatus recommends an item to the user using a plurality of graphs that are composed of user-item nodes according to different evaluation criteria, but the conventional multi-criteria recommender apparatus fails to accurately consider high-dimensional relationships between users and each of multiple criteria. This causes a problem in that user satisfaction with the recommender apparatus is lowered.

### SUMMARY OF THE INVENTION

The present disclosure is directed to providing a multi-criteria recommender apparatus and method capable of accurately recommending an item suitable for a user based on multi-criteria evaluation data that is obtained by evaluating items using multiple criteria.

The present disclosure is also directed to providing a multi-criteria recommender apparatus and method capable of acquiring a multi-criteria extended graph with item nodes expanded to suit a multi-criteria recommendation environment and recommending an item to a user using the acquired multi-criteria extended graph.

The present disclosure is also directed to providing a multi-criteria recommender apparatus and method capable of recommending an item suitable for a user with high recommendation accuracy in consideration of the user's preferred criteria preference among multiple criteria.

According to an aspect of the present disclosure, there is provided a multi-criteria recommender apparatus which includes a memory, and a processor configured to execute at least a portion of an operation of a neural network model stored in the memory, wherein the processor obtains authorization for multi-criteria evaluation data provided by a user evaluating each item according to a plurality of different evaluation criteria to acquire a multi-criteria extended graph including a user node and an item node, wherein the item node is expanded into a plurality of sub-nodes according to the plurality of evaluation criteria, and selects a recommended item in consideration of the user's preferences for the plurality of evaluation criteria on the basis of embedding data that is obtained by performing a neural network operation on the multi-criteria extended graph.

The processor may set the user node and the item node on the basis of the multi-criteria evaluation data, expand the item node into a plurality of sub-nodes according to the number of evaluation criteria, and connect the user node and the respective extended sub-nodes to each other with edges on the basis of the user's evaluation score for each evaluation criterion.

The processor may assign weights to edges connecting the user node and the sub-nodes according to the evaluation criterion corresponding to each of the plurality of sub-nodes.

The importance of each of the plurality of evaluation criteria according to the item may be preset, and the processor may assign weights to the edges connecting the user node and the sub-nodes according to the set importance.

The processor may perform a neural network operation on the multi-criteria extended graph to acquire, as the embedding data, a user vector representing the user node, a sub-vector representing the sub-node, and a preference vector representing the user's preference for each of the plurality of evaluation criteria in an embedding space.

The processor may set arbitrary fixed values to a plurality of criteria vectors representing the plurality of evaluation criteria so that the arbitrary fixed values are spaced apart from each other by a certain distance or more in an embedding space, and allows the plurality of set criteria vectors to be included in the embedding data.

The processor may obtain an item preference, which is the user's preference for the item, and a criterion preference, which is the user's preference for the evaluation criterion, from a plurality of user vectors, a plurality of sub-vectors, a plurality of criteria vectors, and a plurality of preference vectors that are included in the embedding data, and select the recommended item on the basis of the item preference and the criterion preference.

The processor may perform a neural network operation on the plurality of user vectors and the plurality of sub-vectors to estimate the item preference, perform a neural network operation on the plurality of criteria vectors and the plurality of preference vectors to estimate the criterion preference, and select the recommended item on the basis of the item preference and the criterion preference.

The processor may perform a similarity-based operation on the plurality of user vectors and the plurality of sub-vectors to estimate the item preference, perform a similarity-based operation on the plurality of criteria vectors and the plurality of preference vectors to estimate the criterion preference, and select the recommended item on the basis of the item preference and the criterion preference.

According to another aspect of the present disclosure, there is provided a multi-criteria recommender method, which is a recommender method performed by a processor that executes at least a portion of an operation according to a neural network model, which includes obtaining authorization for multi-criteria evaluation data provided by a user evaluating each item according to a plurality of different evaluation criteria, and acquiring a multi-criteria extended graph including a user node and an item node, wherein the item node is expanded into a plurality of sub-nodes according to the plurality of evaluation criteria, and selecting a recommended item in consideration of the user's preferences for the plurality of evaluation criteria on the basis of embedding data that is obtained by performing a neural network operation on the multi-criteria extended graph.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a diagram illustrating components of a multi-criteria recommender apparatus according to an embodiment, which are divided according to operations to be performed;

FIGS. 2A and 2B show examples of single-criteria evaluation data and multi-criteria evaluation data;

FIGS. 3A-3C and 4A-4B are diagrams for describing a method of acquiring a multi-criteria extended graph according to multi-criteria evaluation data;

FIG. 5 illustrates a multi-criteria recommender method according to an embodiment; and

FIG. 6 is a diagram for describing a computing environment including a computing device according to an embodiment.

### DETAILED DESCRIPTION OF EXEMPLARY EMBODIMENTS

Hereinafter, detailed embodiments of the present disclosure will be described with reference to the accompanying drawings. The following detailed description is provided to help comprehensive understanding of methods, apparatuses, and/or systems described in this specification. However, these embodiments are only examples and the present disclosure is not limited thereto.

When embodiments of the present disclosure are described, in a case in which it is determined that detailed descriptions of known technology related to the present disclosure unnecessarily obscure the subject matter of the disclosure, detailed descriptions thereof will be omitted. Some terms described below are defined by considering functions in the present disclosure and meanings may vary depending on, for example, a user or operator's intentions or customs. Therefore, the meanings of terms should be interpreted based on the scope throughout this specification. The terminology used in the following detailed description is only provided to describe embodiments of the present disclosure and not for purposes of limitation. Unless the context clearly indicates otherwise, the singular forms include the plural forms. It will be understood that the terms “comprise” and “include” used herein specify some features, numbers, steps, operations, elements, and parts or combinations thereof, but do not preclude the presence or possibility of one or more other features, numbers, steps, operations, elements, and parts or combinations thereof in addition to those described. Moreover, terms described in the specification such as “part,” “unit,” “device,” “module,” and “block” refer to a unit of processing at least one function or operation and may be implemented as hardware or software or a combination thereof.

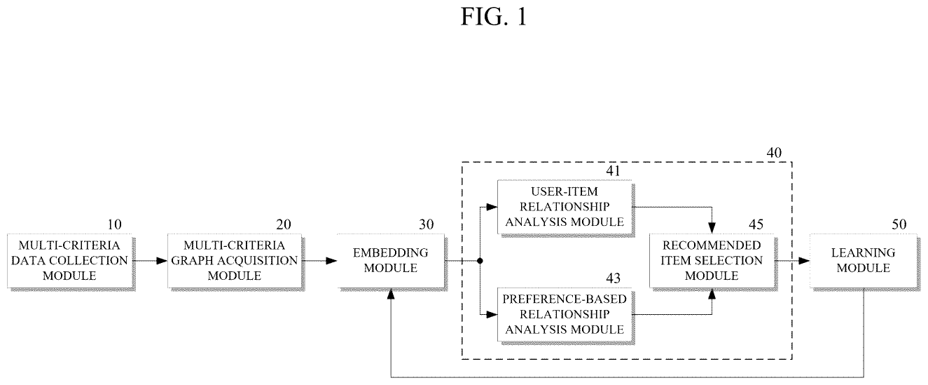

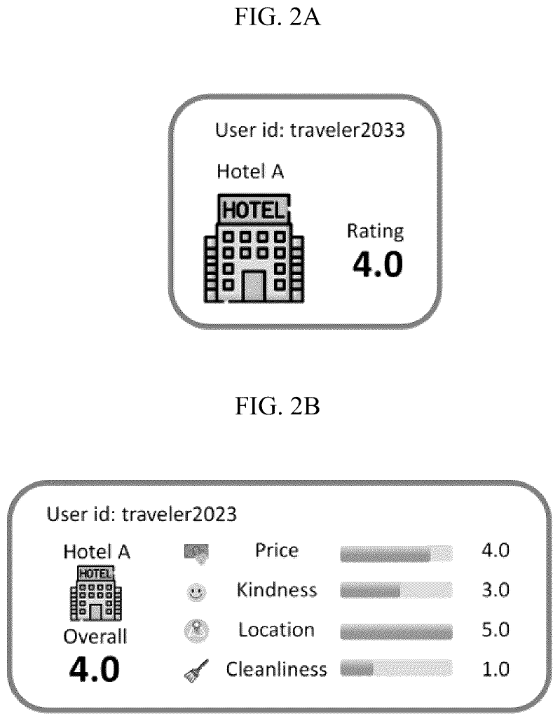

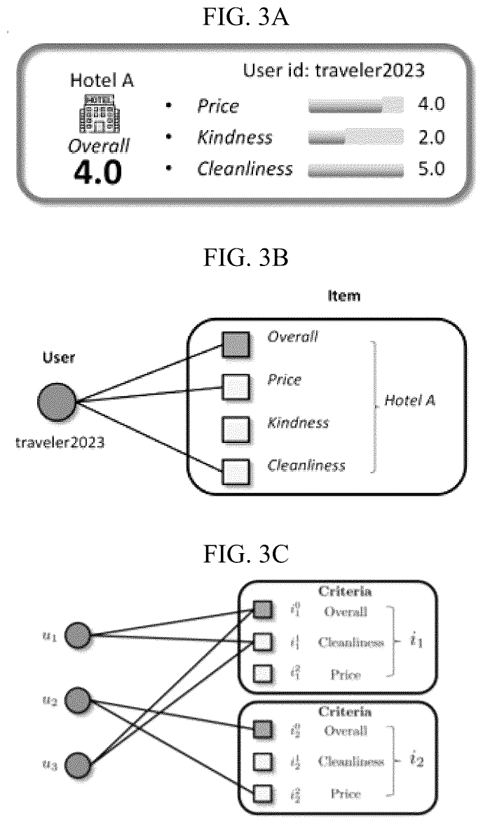

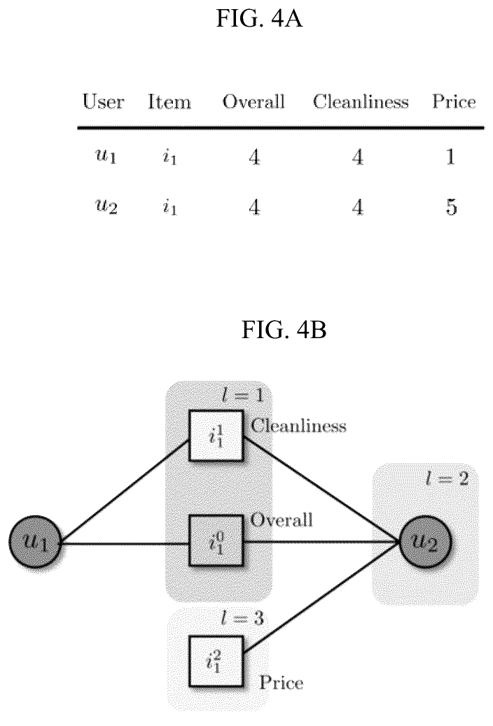

FIG. 1 is a diagram illustrating components of a multi-criteria recommender apparatus according to an embodiment, which are divided according to operations to be performed, and FIGS. 2A and 2B show examples of single-criteria evaluation data and multi-criteria evaluation data. Further, FIGS. 3A-3C and 4A-4B are diagrams for describing a method of acquiring a multi-criteria extended graph according to multi-criteria evaluation data.

Referring to FIG. 1, the multi-criteria recommender apparatus according to the present disclosure may include a multi-criteria data collection module 10, a multi-criteria graph acquisition module 20, an embedding module 30, and an item recommendation module 40.

The multi-criteria data collection module 10 collects multi-criteria evaluation data provided by a plurality of users evaluating a plurality of items according to a plurality of evaluation criteria. Here, the multi-criteria evaluation data may include user identifiers, item identifiers, and evaluation scores for each of multiple criteria. Here, the types and number of criteria for which evaluation scores are given for each criterion may be different from each other depending on the items. Further, in addition to the evaluation scores for each criterion, the multi-criteria evaluation data may include an overall evaluation score for the items, as in the conventional single-criteria evaluation. However, since the overall evaluation score is also an evaluation based on a criterion of all the items, here, for convenience of description, the overall evaluation score will be described in consideration of the fact that the overall evaluation score is also included in the evaluation score for each criterion. In addition, the multi-criteria evaluation data may further include information about various users or items. For example, the multi-criteria evaluation data may include user information such as the user's age or gender, or item information such as the location and price of the item.

FIGS. 2A and 2B show examples of single-criteria evaluation data and multi-criteria evaluation data of a user named traveler 2033 for an item named hotel A, respectively. As shown in FIG. 2A, in the conventional single-criteria evaluation, users' preferences or satisfaction levels for each item are evaluated in the form of a score or grade based on a single criterion. That is, when a user evaluates each item, even though various elements of the item are considered and evaluated, only a result of evaluating the corresponding item as a whole is included in evaluation data.

The multi-criteria evaluation data shown in FIG. 2B is also an evaluation by the same user named traveler 2033 for the same item named Hotel A as in FIG. 2A, the overall evaluation score is also given the same 4 points as in FIG. 2A, and thus it can be said that FIGS. 2A and 2B are the same when only looking at the overall evaluation score. However, in the multi-criteria evaluation data in FIG. 2B, it is different from FIG. 2A in that the user gave hotel A a separate evaluation score for each of four criteria: price, kindness, location, and cleanliness. Further, the difference between the single-criteria evaluation data and the multi-criteria evaluation data is that more detailed information for users to select items is provided, allowing the user to more accurately select an item suitable for him/her.

The users may have different criteria that the users consider important. For example, user A may value location and price, while user B may value cleanliness most. However, it is impossible to determine which parts of the corresponding item the user is satisfied with and which parts he/she is dissatisfied with only the single-criteria evaluation data such as that in FIG. 2A. Therefore, when hotel A is recommended to user B who prioritizes cleanliness on the basis of the single-criterion the data, this recommendation is a factor that reduces the reliability of the recommendation system.

On the other hand, when the multi-criteria evaluation data such as that in FIG. 2B is used, a hotel other than hotel A may be recommended in consideration of cleanliness first, which is an important criterion for user B, and thus recommendation accuracy and reliability can be improved.

However, compared to the single-criteria evaluation data, the multi-criteria evaluation data only has an increased amount of information in the evaluation scores for each criterion, and thus it is very important to use the multi-criteria evaluation data to select recommended items suitable for users. Therefore, in order to efficiently utilize the multi-criteria evaluation data, the multi-criteria recommender apparatus of the present disclosure converts the multi-criteria evaluation data into a graph and allows selection of recommended items using the converted graph.

The multi-criteria data collection module 10 may be implemented as a database or storage device that stores a plurality of pieces of multi-criteria evaluation data, or may be implemented as a communication module that receives a plurality of pieces of multi-criteria evaluation data. Further, the multi-criteria data collection module 10 may be implemented as an input/output module that obtains authorization for multi-criteria evaluations written by the users to generate multi-criteria evaluation data.

Further, the multi-criteria data collection module 10 may not only store a plurality of pieces of multi-criteria evaluation data that have already been generated, but may also additionally collect and store multi-criteria evaluation data that is subsequently generated. Therefore, in the present disclosure, the multi-criteria evaluation data may be generated and added in real time.

The multi-criteria graph acquisition module 20 converts the multi-criteria evaluation data collected by the multi-criteria data collection module 10 into a graph. In this case, the multi-criteria graph acquisition module 20 of the present disclosure acquires a multi-criteria extended evaluation graph with a structure in which an item node expands to be suitable for the multi-criteria evaluation data rather than the single-criteria evaluation data.

As shown in FIG. 2B, when the multi-criteria evaluation data for the item named hotel A of the user named traveler 2033 is obtained as shown in FIG. 3A, the multi-criteria graph acquisition module 20 may generate a graph composed of a user node, an item node, and an edge connecting the user node and the item node. In this case, in the present disclosure, the multi-criteria graph acquisition module 20 may expand the item node into a plurality of sub-nodes according to the number of evaluations for the item, and acquire a multi-criteria graph by connecting each of the expanded sub-nodes and the user on the basis of the evaluation score according to the criteria specified for each sub-node.

For example, referring to FIG. 3B, the multi-criteria graph acquisition module 20 first expands one item node for the item named hotel A into four sub-nodes according to four evaluation criteria of the overall evaluation score, price, friendliness, and cleanliness. In this case, an overall evaluation score node may be an item node in a graph acquired from the conventional single-criteria evaluation data. Further, each of the four expanded sub-nodes is connected to the user node with an edge according to the evaluation score for each sub-node. It is assumed that, when the evaluation score of the item according to the corresponding criterion is higher than or equal to a threshold score (here, for example, 4.0), the multi-criteria graph acquisition module 20 connects the corresponding sub-node to the user node with an edge. In FIG. 3A, the overall evaluation score, the price, and the cleanliness are higher than or equal to threshold scores. Therefore, in FIG. 3B, it can be seen that only three sub-nodes for the overall evaluation scores, the price, and the cleanliness, excluding the sub-node for the friendliness, are connected to the user node with edges. That is, the sub-nodes that are connected to the user node with the edges indicate that the user was satisfied with the item in terms of the corresponding evaluation criterion. On the other hand, the sub-nodes that are not connected to the edge indicate that the user was not satisfied with the item according to the corresponding evaluation criterion.

Since both the users and the items are multiple, the multi-criteria data collection module 10 may collect a plurality of pieces of multi-criteria evaluation data, and the multi-criteria graph acquisition module 20 may form a multi-criteria extended graph as shown in FIG. 3C from the plurality of pieces of multi-criteria evaluation data by expanding each of a plurality of item nodes i₁ and i₂ into a plurality of sub-nodes i₁⁰, i₁¹, i₁², i₂⁰, i₂¹, and i₂² and individually connecting each of the plurality of expanded sub-nodes i₁⁰, i₁¹, i₁², i₂⁰, i₂¹, and i₂² to a plurality of user nodes u₁ to u₃ with edges according to the evaluation score for each criterion of each user.

In the multi-criteria extended graph, each of the user nodes u₁ to u₃ may be connected to the sub-nodes i₁⁰, i₁¹, i₁², i₂⁰, i₂¹, and i₂² of the item nodes i₁ and i₂, and the sub-nodes i₁⁰, i₁¹, i₁², i₂⁰, i₂¹, and i₂² of the item nodes i₁ and i₂ may be connected to the user nodes u₁ to u₃. That is, a user node may not be directly connected to another user node with an edge, and an item node may not be directly connected to another item node with an edge.

Accordingly, as shown in FIG. 4A, when two users each perform a multi-criteria evaluation on the same item, a multi-criteria extended graph may be expressed in the form of a graph shown in FIG. 4B. In FIGS. 4A and 4B, it is assumed that a threshold score is 4.0, and accordingly, a first user node u₁ is connected to two sub-nodes i₁⁰ and i₁¹ with edges among three sub-nodes i₁⁰, i₁¹, and i₁² of a first item node i₁, while a second user node u₂ is connected to all three sub-nodes i₁⁰, i₁¹, and i₁² of the first item node i₁ with edges.

In the multi-criteria extended graph expanded as shown in FIG. 4B, the edge represents the connectivity between the users and the items, and an edge path connecting a specific user node and a specific sub-node represents the dimension of connectivity. That is, the greater the number of edges connected between the specific user and the specific sub-node, the higher the connection.

In the example in FIG. 4B, based on the first user node u₁, the first and second sub-nodes i₁⁰ and i₁¹ of the first item node i₁ are directly connected to the first user node u₁ with one edge. On the other hand, since the remaining third sub-node i₁² is not directly connected to the first user node u₁, the remaining third sub-node i₁² is connected to the first user node u₁ through a second user node u₂ connected to the first and second sub-nodes i₁⁰ and i₁¹ of the first item node i₁. That is, the first user node u₁ may be connected to the third sub-node i₁² of the first item node i₁ through a tertiary connection.

In this case, the multi-criteria graph acquisition module 20 may assign different weights to the edges connected to the respective sub-nodes i₁⁰, i₁¹, and i₁². For example, individual criteria such as friendliness, price, and cleanliness, and the overall evaluation may not be considered to have the same importance. In general, the overall evaluation should take precedence over other individual criteria. Accordingly, the multi-criteria graph acquisition module 20 may assign a higher weight to the edge connecting the sub-node and the user node for the overall evaluation compared to the edge connecting the sub-node and the user node according to other individual criteria. Further, even on the individual criteria, different weights may be assigned depending on the type of each item. For example, when the item is food for delivery, cleanliness or location may need to be considered relatively more important than criteria such as price or friendliness. Accordingly, the multi-criteria graph acquisition module 20 may assign different weights for each edge connected to the plurality of sub-nodes according to individual criteria. In this case, the weights for the edges connected to the respective sub-nodes may be preset according to the items.

The multi-criteria graph acquisition module 20 may generate a multi-criteria extended graph on the basis of a plurality of pieces of multi-criteria evaluation data previously stored in the multi-criteria data collection module 10. Further, when the multi-criteria evaluation data is added to the multi-criteria data collection module 10, nodes according to the added multi-criteria evaluation data may be added to the already generated multi-criteria extended graph and connected with edges, and thus a multi-criteria extended graph reflecting the added multi-criteria evaluation data may also be acquired.

When the multi-criteria extended graph is acquired by the multi-criteria graph acquisition module 20, the embedding module 30 obtains embedding data of the item recommendation module 40 by obtaining authorization and embedding the acquired multi-criteria extended graph.

The embedding module 30 may be implemented with an artificial neural network, and obtains the embedding data of the item recommendation module 40 by performing a neural network operation on the multi-criteria extended graph. In this case, the embedding module 30 may embed a plurality of user nodes and a plurality of sub-nodes of the multi-criteria extended graph into a virtual embedding space to obtain a plurality of user vectors eᵤ and a plurality of sub-vectors eᵢ_{^{c}} as embedding data. That is, by vectorizing all the nodes of the multi-criteria extended graph, it is possible to obtain the plurality of user vectors eᵤ and the plurality of sub-vectors eᵢ_{^{c}} which are embedding data.

In the conventional recommender apparatus using a single-criteria graph, user vectors eᵤ representing the features of each user and item vectors representing the features of the item are obtained from the graph, but in the present disclosure, a multi-criteria extended graph in which an item node is expanded into a plurality of sub-nodes is used, and thus a plurality of sub-vectors eᵢ_{^{c}} expanded for each item are obtained according to the expanded sub-nodes. Here, each of the plurality of sub-vectors eᵢ_{^{c}} can be viewed as representing the characteristics of the item according to the evaluation criterion corresponding to the sub-node.

Further, in the present disclosure, the embedding module 30 further extracts a plurality of criteria preference vectors pᵤ and a plurality of criteria vectors p_{c} as embedding data, in addition to the plurality of user vectors eᵤ and the plurality of sub-vectors eᵢ_{^{c}}, from the multi-criteria extended graph.

As described above, in the case of the conventional graph-based recommender apparatus, the user vector eᵤ and the item vector are obtained by embedding only the obtained nodes of the graph. However, the user vector eᵤ and the sub-vector eᵢ_{^{c}} are useful for expressing the features of the item itself according to the evaluation criteria corresponding to the user and sub-node, but it is not effective in expressing the features according to the evaluation criteria that divide the item nodes i₁ and i₂ into the plurality of sub-nodes i₁⁰, i₁¹, i₁², i₂⁰, i₂¹, and i₂².

Accordingly, the embedding module 30 performs a neural network operation on the multi-criteria extended graph to further extract the plurality of criteria preference vectors pᵤ and the plurality of criteria vectors p_{c} according to the connection relationships between the plurality of user nodes and the sub-nodes according to each evaluation criterion. Here, the plurality of criteria vectors p_{c} are vectors for expressing the evaluation criteria themselves in the embedding space, and the plurality of criteria preference vectors pᵤ are vectors for expressing the evaluation criteria that each user gives higher priority among a plurality of evaluation criteria.

Here, the user vector eᵤ, the sub-vector eᵢ_{^{c}}, and the criteria preference vector pᵤ are extracted by the embedding module 30, while each of the plurality of criteria vectors p_{c} may have an arbitrary fixed value determined in advance. That is, the user vector eᵤ, the sub-vector eᵢ_{^{c}}, and the criteria preference vector pᵤ are values extracted by the embedding module 30 and may be changed depending on a training state of the embedding module 30. On the other hand, a pre-given vector that does not change through training of the embedding module 30 may be set to the criteria vector p_{c}. In this case, the plurality of criteria vectors p_{c} may be set to have values that are spaced apart from each other by a certain distance or more in the embedding space. This setting is to enable the user to easily confirm the user's preferred evaluation criteria later using the criteria preference vector pᵤ.

Since the plurality of criteria vectors p_{c} have fixed values, the plurality of criteria vectors p_{c} may not be output from the embedding module 30 but may be directly input to the item recommendation module 40. However, in order for the embedding module 30 to extract the required criteria preference vector pᵤ from the multi-criteria extended graph, it is more desirable to use the plurality of criteria vectors p_{c} together, and accordingly, the plurality of criteria vectors p_{c} may be applied as inputs to the embedding module 30 or may be included as predetermined values in the embedding module 30.

The item recommendation module 40 obtains authorization for the user vector eᵤ, the sub-vector eᵢ_{^{c}}, the criteria preference vector pᵤ, and the criteria vector p_{c} as the embedding data from the embedding module 30, and selects and recommends an item in consideration of the user's preference on the basis of the authorized user vector eᵤ, sub-vector eᵢ_{^{c}}, criteria preference vector pᵤ, and criteria vector p_{c}.

The item recommendation module 40 selects an item to recommend to the user by analyzing a relationship between the user and the item from the user vector eᵤ and the sub-vector eᵢ_{^{c}}, and at the same time, analyzing the plurality of evaluation criteria and the user's preference for the criteria.

The item recommendation module 40 may include a user-item relationship analysis module 41, a preference-based relationship analysis module 43, and a recommended item selection module 45. For example, the user-item relationship analysis module 41 may obtain authorization for the user vector eᵤ and the sub-vector eᵢ_{^{c}}, and analyze the user's item preference on the basis of the authorized user vector eᵤ and sub-vector eᵢ_{^{c}}, and the preference-based relationship analysis module 43 may obtain authorization for the criteria preference vector pᵤ and the criteria vector p_{c}, and analyze the criterion preference indicating the user's preferred evaluation criterion among the plurality of evaluation criteria.

Further, the recommended item selection module 45 selects an item suitable for the user from among a plurality of items on the basis of the item preference and the criterion preference and outputs the selected item as a recommended item. For example, the recommended item selection module 45 may sort the plurality of items according to suitability for each user, and select and output a top item from among the sorted items as a recommended item.

Here, for convenience of understanding, the user-item relationship analysis module 41 and the preference-based relationship analysis module 43 are simplified and expressed, but the user-item relationship analysis module 41 and the preference-based relationship analysis module 43 may include a plurality of layers to consider the higher-order connectivity between the users and the items and the higher-order connectivity between the user's preference for the evaluation criteria and each criterion. Here, the number of layers may correspond to the number of edges connecting a specific node and other nodes in the multi-criteria extended graph shown in FIG. 4B.

As a result, the multi-criteria recommender apparatus according to the present disclosure may acquire the multi-criteria extended graph suitable for the multi-criteria evaluation data, extract the criteria preference vector pᵤ and the criteria vector p_{c} as well as the user vector eᵤ and the sub-vector eᵢ_{^{c}} from the acquired multi-criteria extended graph, and select the recommended item using the extracted user vector eᵤ, sub-vector eᵢ_{^{c}}, criteria preference vector pᵤ, and criteria vector p_{c}, thereby accurately selecting and recommending an item that take the user's preferences into consideration.

The item recommendation module 40 may be implemented with an artificial neural network to recommend an item by performing a neural network operation, or may be configured to recommend an item by performing a calculation according to an algorithm.

However, in order for the multi-criteria recommender apparatus of the present disclosure to operate correctly, pre-training should be performed. In particular, the embedding module 30 implemented with an artificial neural network should be trained. Accordingly, during the training, the multi-criteria recommender apparatus may further include a learning module 50. When the recommended item is a sub-node connected to the user node with a small number of edges in the multi-criteria extended graph, the learning module 50 may calculate the loss by setting the loss so that the recommended item is placed closer in the embedding space and the sub-node connected to the user node with a large number of edges is placed further away in the embedding space, and may train the embedding module 30 by back-propagating the calculated loss. For example, the learning module 50 may train the embedding module 30 using Bayesian personalized ranking (BPR) loss, which is frequently used when training a graph neural network. Further, when the item recommendation module 40 is implemented with an artificial neural network, the learning module 50 may backpropagate the loss to the embedding module 30 through the item recommendation module 40, but when the item recommendation module 40 is not implemented with an artificial neural network, the learning module 50 may perform training by backpropagating the loss directly to the embedding module 30.

In the illustrated embodiment, each component may have different functions and capabilities in addition to those described below, and may include additional components other than those described below. Further, in an embodiment, each component may be implemented using one or more physically separate devices, one or more processors, or a combination of one or more processors and software, and, unlike the shown examples, specific operations may not be clearly distinguished.

Further, the multi-criteria recommender apparatus illustrated in FIG. 1 may be implemented in a logic circuit using hardware, firmware, software, or a combination thereof, and may also be implemented using a general-purpose or special-purpose computer. The multi-criteria recommender apparatus may be implemented using hardwired devices, field programmable gate arrays (FPGAs), application specific integrated circuits (ASICs), etc. Further, the multi-criteria recommender apparatus may be implemented as a system on chip (SoC) including one or more processors and a controller.

In addition, the multi-criteria recommender apparatus may be mounted on a computing device or server equipped with hardware elements in the form of software, hardware, or a combination thereof. The computing device or the server may be various devices that include all or part of communication devices such as communication modems for communicating with various devices or wired and wireless communication networks, memories for storing data for executing programs, microprocessors for executing programs to perform calculations and commands, etc.

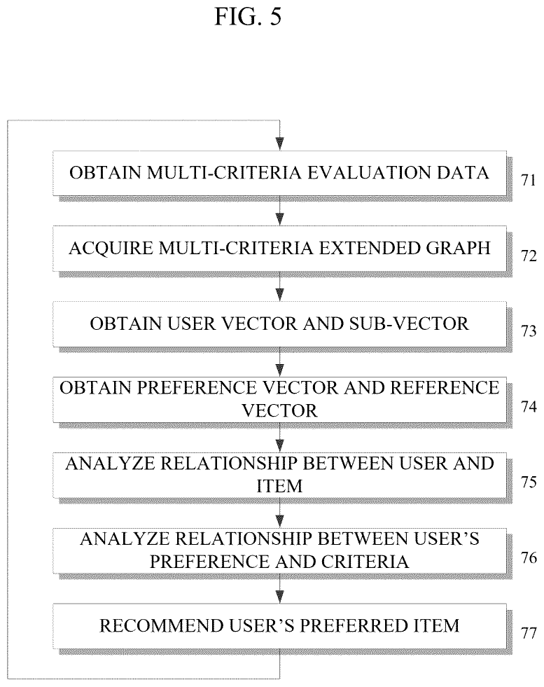

FIG. 5 illustrates a multi-criteria recommender method according to an embodiment.

Referring to FIG. 5, in the multi-criteria recommender method according to the present disclosure, first, multi-criteria evaluation data provided by a plurality of users evaluating each of a plurality of items according to various criteria is collected and obtained (71).

When the multi-criteria evaluation data is obtained, a multi-criteria extended graph is acquired (72). Here, the plurality of users and the plurality of items may each be set as nodes in the multi-criteria evaluation data, each item node may be expanded into a plurality of sub-nodes according to a plurality of evaluation criteria, and the multi-criteria extended graph may be acquired by connecting the user nodes and the sub-nodes with edges according to the user's evaluation by criteria.

When the multi-criteria extended graph is acquired, a neural network operation is performed on the acquired multi-criteria extended graph, a user vector and a sub-vector representing the features of each user node and sub-node of the multi-criteria extended graph, that is, the features of each evaluation criterion of the user and item, are extracted and obtained (73). In addition, as a result of the neural network operation for the multi-criteria extended graph, a preference vector and a criteria vector representing the user's preference for the evaluation criterion and the features of the evaluation criterion itself are obtained (74).

When the user vector, the sub-vector, the preference vector, and the criteria vector are obtained, a relationship between the user and the item is analyzed from the user vector and the sub-vector (75). In addition, a relationship between the preference vector and the criteria vector is analyzed (76). Thereafter, according to the analyzed relationship between the user-items and the analyzed relationship between the preference vector and the criteria vector, the item suitable for the user is selected from among the plurality of evaluation criteria according to the user's preferred evaluation criterion and output as the recommended item (77).

In FIG. 5, the respective processes are described as being sequentially executed, but this is only an illustrative explanation, and those skilled in the art can change the order shown in FIG. 5 and execute the processes without departing from the essential characteristics of the embodiments of the present disclosure, or the processes may be applied through various modifications and alternative forms by executing one or more processes in parallel or adding other processes.

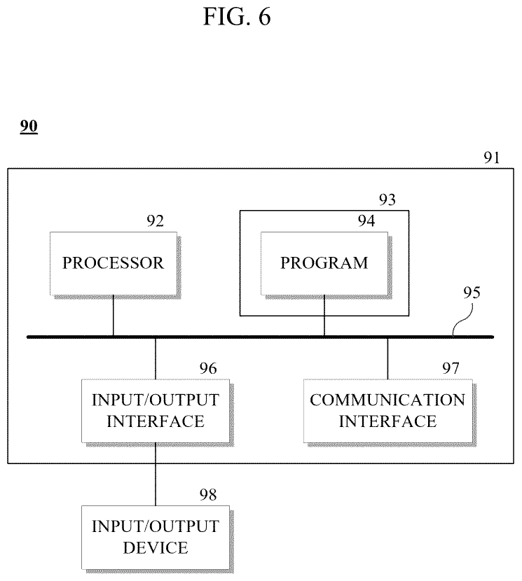

FIG. 6 is a diagram for describing a computing environment including a computing device according to an embodiment.

In the illustrated embodiment, each component may have different functions and capabilities in addition to those described below, and may include additional components other than those described below. An illustrated computing environment 90 may include a computing device 91 to perform the multi-criteria recommender method shown in FIG. 5. In an embodiment, the computing device 91 may be one or more components included in the multi-criteria recommender apparatus illustrated in FIG. 1.

The computing device 91 includes at least one processor 92, a non-transitory computer-readable storage medium 93, and a communication bus 95. The processor 92 may cause the computing device 91 to operate according to the example embodiments described above. For example, the processor 92 may execute one or more programs 94 stored in the non-transitory computer-readable storage medium 93.

The one or more programs 94 may include one or more computer executable instructions, and the computer executable instructions, when executed by the processor 92, may be configured to cause the computing device 91 to perform operations according to exemplary embodiments.

The communication bus 95 interconnects various other components of the computing device 91, including the processor 92 and the computer-readable storage medium 93.

The computing device 91 may also include one or more input/output interfaces 96 and one or more communication interfaces 97 that provide interfaces for one or more input/output devices 98. The input/output interface 96 and the communication interface 97 are connected to the communication bus 95. The input/output device 98 may be connected to other components of the computing device 91 through the input/output interfaces 96. The exemplary input/output device 98 may include input devices such as pointing devices (e.g., a mouse or trackpad), keyboards, touch input devices (e.g., a touchpad or touch screen), voice or sound input devices, various types of sensor devices and/or imaging devices, and/or output devices such as display devices, printers, speakers, and/or network cards. The exemplary input/output device 98 may be a component constituting the computing device 91 and may be included within the computing device 91, or may be a separate device that is distinct from the computing device 91 and may be connected to the computing device 91.

In the multi-criteria recommender apparatus and method of the present disclosure, it is possible to acquire a multi-criteria extended graph in which item nodes are expanded to be suitable for a multi-criteria recommendation environment from multi-criteria evaluation data provided by evaluating items on the basis of multiple criteria, and accurately recommend an item suitable for the user with high recommendation accuracy in consideration of the user's preferred criterion among multiple criteria together with the acquired multi-criteria extended graph.

While the present disclosure has been described with reference to embodiments illustrated in the accompanying drawings, these should be considered in a descriptive sense only and it will be understood by those skilled in the art that various alterations and other equivalent embodiments may be made. Therefore, the scope of the present disclosure is defined by the appended claims.

What is claimed is:

1. A multi-criteria recommender apparatus comprising:
a memory; and
a processor configured to execute at least a portion of an operation of a neural network model stored in the memory,
wherein the processor obtains authorization for multi-criteria evaluation data provided by a user evaluating each item according to a plurality of evaluation criteria to acquire a multi-criteria extended graph including a user node and an item node, wherein the item node is expanded into a plurality of sub-nodes according to the plurality of evaluation criteria, and selects a recommended item in consideration of the user's preferences for the plurality of evaluation criteria on the basis of embedding data that is obtained by performing a neural network operation on the multi-criteria extended graph.

2. The multi-criteria recommender apparatus of claim 1, wherein the processor is configured to:
set the user node and the item node on the basis of the multi-criteria evaluation data;
expand the item node into the plurality of sub-nodes according to the plurality of evaluation criteria; and
connect the user node and the respective sub-nodes to each other with edges on the basis of the user's evaluation score for each evaluation criterion.

3. The multi-criteria recommender apparatus of claim 1, wherein the processor assigns weights to edges connecting the user node and the sub-nodes according to the evaluation criterion corresponding to each of the plurality of sub-nodes.

4. The multi-criteria recommender apparatus of claim 3, wherein importance of each of the plurality of evaluation criteria according to the item is preset, and the processor assigns weights to the edges connecting the user node and the sub-nodes according to the set importance.

5. The multi-criteria recommender apparatus of claim 1, wherein the processor performs a neural network operation on the multi-criteria extended graph to acquire, as the embedding data, a user vector representing the user node, a sub-vector representing the sub-node, and a preference vector representing the user's preference for each of the plurality of evaluation criteria in an embedding space.

6. The multi-criteria recommender apparatus of claim 1, wherein the processor sets arbitrary fixed values to a plurality of criteria vectors representing the plurality of evaluation criteria so that the arbitrary fixed values are spaced apart from each other by a certain distance or more in an embedding space, and allows the plurality of set criteria vectors to be included in the embedding data.

7. The multi-criteria recommender apparatus of claim 1, wherein the processor obtains an item preference, which is the user's preference for the item, and a criterion preference, which is the user's preference for the evaluation criterion, from a plurality of user vectors, a plurality of sub-vectors, a plurality of criteria vectors, and a plurality of preference vectors that are included in the embedding data, and selects the recommended item on the basis of the item preference and the criterion preference.

8. The multi-criteria recommender apparatus of claim 7, wherein the processor is configured to:
perform a neural network operation on the plurality of user vectors and the plurality of sub-vectors to estimate the item preference;
perform a neural network operation on the plurality of criteria vectors and the plurality of preference vectors to estimate the criterion preference; and
select the recommended item on the basis of the item preference and the criterion preference.

9. The multi-criteria recommender apparatus of claim 7, wherein the processor is configured to:
perform a similarity-based operation on the plurality of user vectors and the plurality of sub-vectors to estimate the item preference;
perform a similarity-based operation on the plurality of criteria vectors and the plurality of preference vectors to estimate the criterion preference; and
select the recommended item on the basis of the item preference and the criterion preference.

10. A multi-criteria recommender method, which is a recommender method performed by a processor that executes at least a portion of an operation according to a neural network model, comprising:
obtaining authorization for multi-criteria evaluation data provided by a user evaluating each item according to a plurality of evaluation criteria, and acquiring a multi-criteria extended graph including a user node and an item node, wherein the item node is expanded into a plurality of sub-nodes according to the plurality of evaluation criteria; and
selecting a recommended item in consideration of the user's preferences for the plurality of evaluation criteria on the basis of embedding data that is obtained by performing a neural network operation on the multi-criteria extended graph.

11. The multi-criteria recommender method of claim 10, wherein, in the acquiring of the multi-criteria extended graph,
the user node and the item node are set based on the multi-criteria evaluation data,
the item node is expanded into the plurality of sub-nodes according to the plurality of evaluation criteria, and
the user node and the respective sub-nodes are connected to each other with edges on the basis of the user's evaluation score for each evaluation criterion.

12. The multi-criteria recommender method of claim 10, wherein, in the acquiring of the multi-criteria extended graph,
weights are assigned to edges connecting the user node and the sub-nodes according to the evaluation criterion corresponding to each of the plurality of sub-nodes.

13. The multi-criteria recommender method of claim 12, wherein, in the acquiring of the multi-criteria extended graph,
importance of each of the plurality of evaluation criteria according to the item is preset, and weights are assigned to the edges connecting the user node and the sub-nodes according to the set importance.

14. The multi-criteria recommender method of claim 10, wherein, in the selecting of the recommended item,
a neural network operation is performed on the multi-criteria extended graph to obtain, as the embedding data, a user vector representing the user node, a sub-vector representing the sub-node, and a preference vector representing the user's preferences for each of the plurality of evaluation criteria in an embedding space.

15. The multi-criteria recommender method of claim 10, wherein, in the selecting of the recommended item,
arbitrary fixed values are set to a plurality of criteria vectors representing the plurality of evaluation criteria so that the arbitrary fixed values are spaced apart from each other by a certain distance or more in an embedding space, and the plurality of set criteria vectors are included in the embedding data.

16. The multi-criteria recommender method of claim 10, wherein, in the selecting of the recommended item,
an item preference, which is the user's preference for the item, and a criterion preference, which is the user's preference for the evaluation criteria, are obtained from a plurality of user vectors, a plurality of sub-vectors, a plurality of criteria vectors, and a plurality of preference vectors that are included in the embedding data, and the recommended item is selected based on the item preference and the criterion preference.

17. The multi-criteria recommender method of claim 16, wherein, in the selecting of the recommended item,
a neural network operation is performed on the plurality of user vectors and the plurality of sub-vectors to estimate the item preference,
a neural network operation is performed on the plurality of criteria vectors and the plurality of preference vectors to estimate the criterion preference, and
the recommended item is selected based on the item preference and the criterion preference.

18. The multi-criteria recommender method of claim 16, wherein, in the selecting of the recommended item,
a similarity-based operation is performed on the plurality of user vectors and the plurality of sub-vectors to estimate the item preference,
a similarity-based operation is performed on the plurality of criteria vectors and the plurality of preference vectors to estimate the criterion preference, and
the recommended item is selected based on the item preference and the criterion preference.
